(19) United States
(12) Patent Application Publication
(10) Pub. No.: US 2018/0056337 A1
(43) Pub. Date: Mar. 1, 2018

(54) DISPOSABLE DOUBLE LAYERED CLEANING AND DISINFECTING WIPES SYSTEM AND METHOD

(71) Applicant: Steven M. Pelletier, North Smithfield, RI (US)

(72) Inventor: Steven M. Pelletier, North Smithfield, RI (US)

(21) Appl. No.: 15/248,883

(22) Filed: Aug. 26, 2016

(51) Int. Cl. B08B 1/00; C11D 3/30; C11D 3/22; C11D 3/33; C11D 3/20; C11D 3/48; C11D 17/04; A01N 31/02; A01N 33/12; A01N 43/16; A01N 33/08

(52) U.S. Cl. CPC B08B 1/006; C11D 3/30; C11D 3/222; C11D 3/33; C11D 3/2068; A01N 33/08; C11D 3/48; C11D 17/049; A01N 31/02; A01N 33/12; A01N 43/16; C11D 3/201

(57) ABSTRACT

A disposable double layered cleaning and disinfecting wipes system and method for cleaning and disinfecting a dirty surface and drying a cleaned surface with the same disposable cloth. The double layered wipes include a first layer composed of threaded cloth and coated with a liquid chemical formula for cleaning and disinfecting the dirty surface. A second layer of the double layered wipes is composed of micro-fiber cloth and is used for drying the cleaned surface.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of cleaning wipes and more specifically relates to disposable double layered cleaning and disinfecting wipes.

### 2. Description of Related Art

Cleaning wipes have included soaps and detergents to clean hard surfaces such as tiles, ceramics, counter tops, floors, and the like, as well as soft surfaces such as fabrics and upholstery. Wipes have been formulated with personal care products, for example to clean an individual's hands. Cleaning wipes have also included ammonia to clean glass surfaces.

The use of smartphones, PDAs and small notebook computers has increased the need for a material to clean the screen. Devices which are used as a telephone or which have a touch screen commonly come into contact with oils from a user's ears or hands which can leave smudges making it more difficult to view items through the display. Furthermore, dirt can be attracted to the oils on the screen, making the screen even more difficult to use. As a consequence of this, it is not uncommon for individuals to use a shirt sleeve or other piece of clothing to clean the display to remove smudges.

Mobile phones are a huge part of everyday life and are only getting more popular. They are taken everywhere with a person; living in their pockets and purses and constantly set upon any available surface whether that be a park bench or table in a restaurant. It is also a well-known fact that bacteria thrive in warm places. Not only does a smartphone generate its own heat, but it also gets warmth from your own body heat by spending time in your hands and next to your mouth.

Typical mobile phones have more bacteria than an office workspace, and some have even more than a toilet seat. An article published in 2009 in the journal “Annals of Clinical Microbiology and Antimicrobials” details a study involving the mobile phones of 200 hospital staff members. The researchers found that 94.5 percent of the phones were contaminated with some kind of bacteria, many of which were resistant to multiple antibiotics. Additional studies have found colonies of streptococcus, staphylococcus, MRSA (methicillin-resistant staphylococcus aureus) infection and diphtheroids on people's cell phones. Further to this, it was found that 1 in 6 mobile phones have fecal matter on them and every square inch of a cell phone contains roughly 25,000 germs, making it one of the most bacteria ridden things a person comes in contact with every day

Additional to the issue with mobile communication devices is that of eyeglasses. Those who wear glasses will readily appreciate that throughout the day oils from the skin and airborne dust and other contaminants cling to the lenses of a pair of glasses. Over the course of a day the build-up of oils and other contaminants can substantially interfere with the comfort and ability of a person to see through their lenses. Consequently, it is common for a person who wears glasses to periodically remove them and wipe them with a cloth or other article of clothing. A suitable solution is desired.

Several attempts have been made to solve the above-mentioned problems such as those found in U.S. Pub. Nos. 2012/0227203 to Ouellette, 2009/0235478 to England, and U.S. Pat. No. 7,431,983 to Amano. This art is representative of cleaning wipes. However, none of the above inventions and patents, taken either singly or in combination, is seen to describe the invention as claimed.

### BRIEF SUMMARY OF THE INVENTION

In view of the foregoing disadvantages inherent in the known cleaning wipes art, the present invention provides a novel disposable double layered cleaning and disinfecting wipes system. The general purpose of the present invention, which will be described subsequently in greater detail is to provide a means of cleaning and disinfecting a surface and a means of drying the same surface combined into one disposable wipe.

A disposable double layered cleaning and disinfecting wipes system and method is disclosed herein, in a preferred embodiment, comprising a square-shaped disposable cloth including a first layer composed of a threaded cloth material, a second layer composed of a micro-fiber cloth material, an adhesive, and a liquid chemical formula having at least one cleaning and disinfecting agent.

The disposable cloth is defined by the first layer and the second layer coupled together via the adhesive. The first layer of the disposable cloth may be composed of a threaded cloth material configured to grip to and remove dirt particles from a dirty surface. The first layer of the disposable cloth is coated with the liquid chemical formula. The liquid chemical formula may comprise in fluid combination a water component, an isopropyl alcohol component, an alkyl dimethyl benzyl ammonium chloride component, an alkyl polyglucoside component, a disodium ethylenediaminetetraacetic acid component, a propylene glycol propyl ether component, and at least one fragrance component.

The second layer of the disposable cloth may be composed of a micro-fiber cloth material and is configured to provide a dry surface useful for the absorption of the liquid chemical formula from a cleaned surface.

The first layer of the disposable double layered cleaning and disinfecting wipes is configured to clean the dirty surface and the second layer of the disposable double layered cleaning and disinfecting wipes is configured to dry the dirty surface. The disposable double layered cleaning and disinfecting wipe is disposable after use in an environmentally-friendly manner.

The dirty surface may include a display screen of a mobile communication device, a camera lens, an eyeglass lens, a mirror, a glass surface, a television screen, a display screen of a computer tablet, a display screen of a digital camera, and a display screen of a desktop computer monitor.

The disposable double layered cleaning and disinfecting wipes system may comprise a kit including: the disposable cloth, the liquid chemical formula having at least one cleaning and disinfecting agent, a disposable package configured to retain the disposable cloth and the liquid chemical formula, and a set of user instructions.

According to another embodiment, a method for using disposable double layered cleaning and disinfecting wipes is also disclosed herein. The method of use comprises the steps of: tearing the disposable package, opening the disposable package, removing the disposable double layered cleaning and disinfecting wipe, unfolding the disposable double layered cleaning and disinfecting wipe, wiping the first layer of the disposable double layered cleaning and disinfecting wipe over a dirty surface, drying the cleaned surface with the second layer of the disposable double layered cleaning and disinfecting wipes, and disposing of the disposable double layered cleaning and disinfecting wipe.

The present invention holds significant improvements and serves as a disposable double layered cleaning and disinfecting wipes system. Preferably, cleaning wipes should provide a means of cleaning and disinfecting a surface and a means of drying the same surface combined into one disposable wipe and, yet would operate reliably and be manufactured at a modest expense. Thus, a need exists for a reliable disposable double layered cleaning and disinfecting wipes system and method to avoid the above-mentioned problems.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present disclosure, disposable double layered cleaning and disinfecting wipes system and method, constructed and operative according to the teachings of the present disclosure.

FIG. 1A shows a perspective view illustrating a disposable double layered cleaning and disinfecting wipes and method during an ‘in-use’ condition useful for cleaning and disinfecting a dirty display screen of a mobile communication device according to an embodiment of the disclosure.

FIG. 1B shows a perspective view illustrating the disposable double layered cleaning and disinfecting wipes system and method during another ‘in-use’ condition useful for drying the display screen of the mobile communication device according to an embodiment of the disclosure.

FIG. 2 is a perspective view illustrating the disposable double layered cleaning and disinfecting wipes system and method comprising a disposable cloth according to an embodiment of the present invention of the disclosure.

FIG. 3 is a side perspective view illustrating the disposable cloth comprising a first layer, a second layer, and an adhesive coupling the first layer and the second layer together according to an embodiment of the present disclosure.

FIG. 4 is a perspective view illustrating a disposable package useful for retaining the disposable cloth according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to cleaning wipes and more particularly to disposable double layered cleaning wipes as used to improve the means of cleaning, disinfecting and drying a surface using one combined disposable wipe.

Generally speaking, the present invention is configured to provide a disposable double layered lens, glass and electronic display screen cleaning and disinfecting wipes. The disposable cloth includes a first layer for cleaning and disinfecting the lens, glass and electronic display screen and a second layer for drying the cleaned lens, glass or electronic display screen.

The first layer of the disposable cloth may be doused with a cleaning and disinfecting agent. The cleaning and disinfecting agent may include water, isopropyl alcohol, alkyl dimethyl benzyl ammonium chloride, alkyl polyglucoside, disodium ethylenediaminetetraacetic acid, propylene glycol propyl ether and a fragrance agent.

The second layer of the disposable cloth may comprise a drying section made of micro-fiber cloth providing the advantage of a combined drying section having absorption qualities for absorbing the cleaning and disinfecting agent after wiping a dirty surface.

The first layer is coated with a cleaning and disinfecting agent and made of threaded cloth to facilitate removal of dust, oil, finger prints, and moisture from lens, glass and electronic display screen while cleaning and disinfecting. The second layer may be fabricated of micro-fiber cloth and may facilitate the drying of lens, glass and electronic display screen.

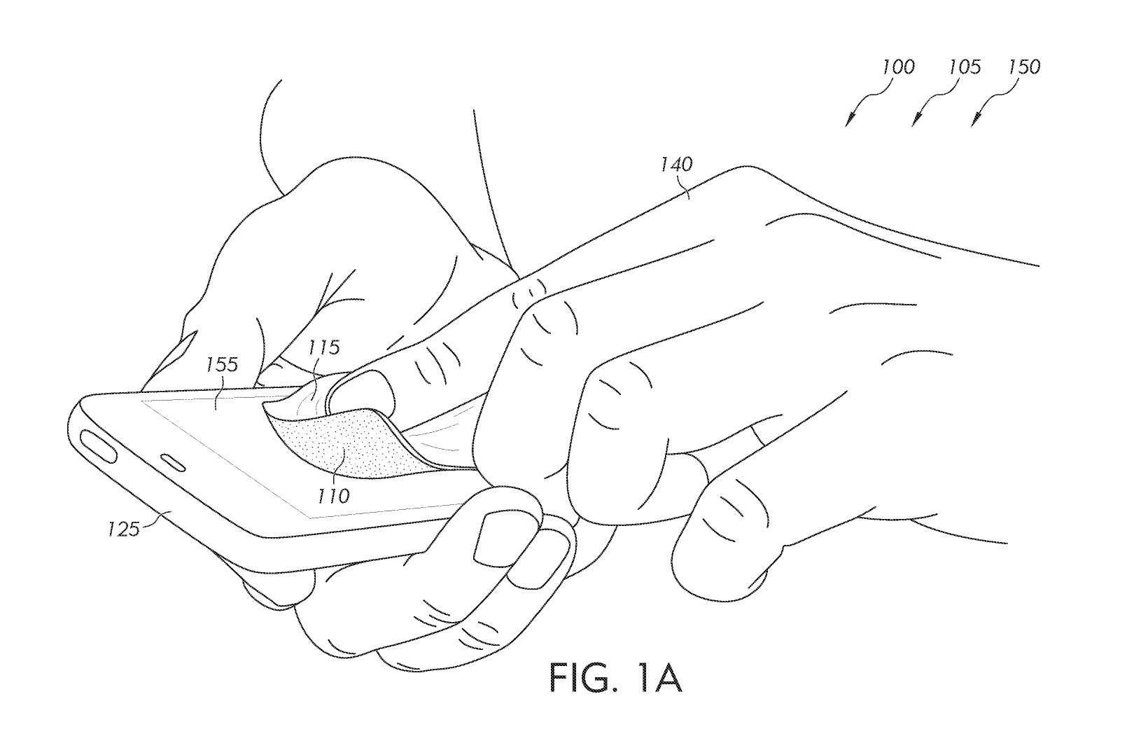

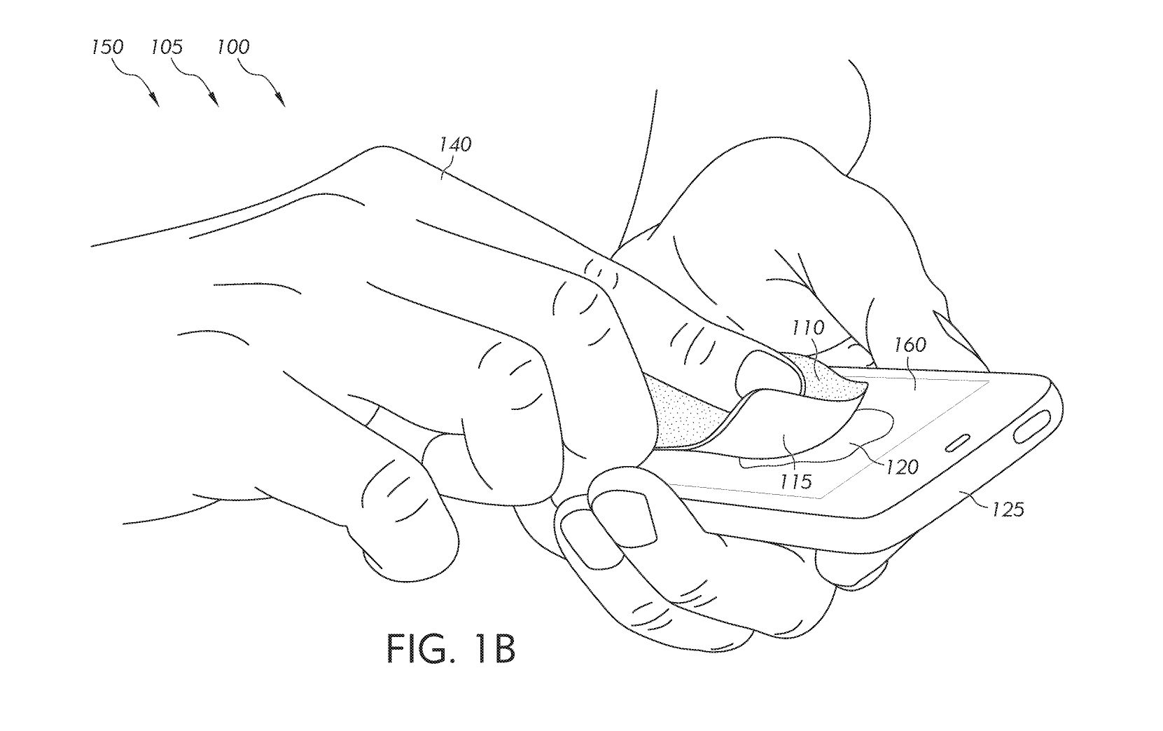

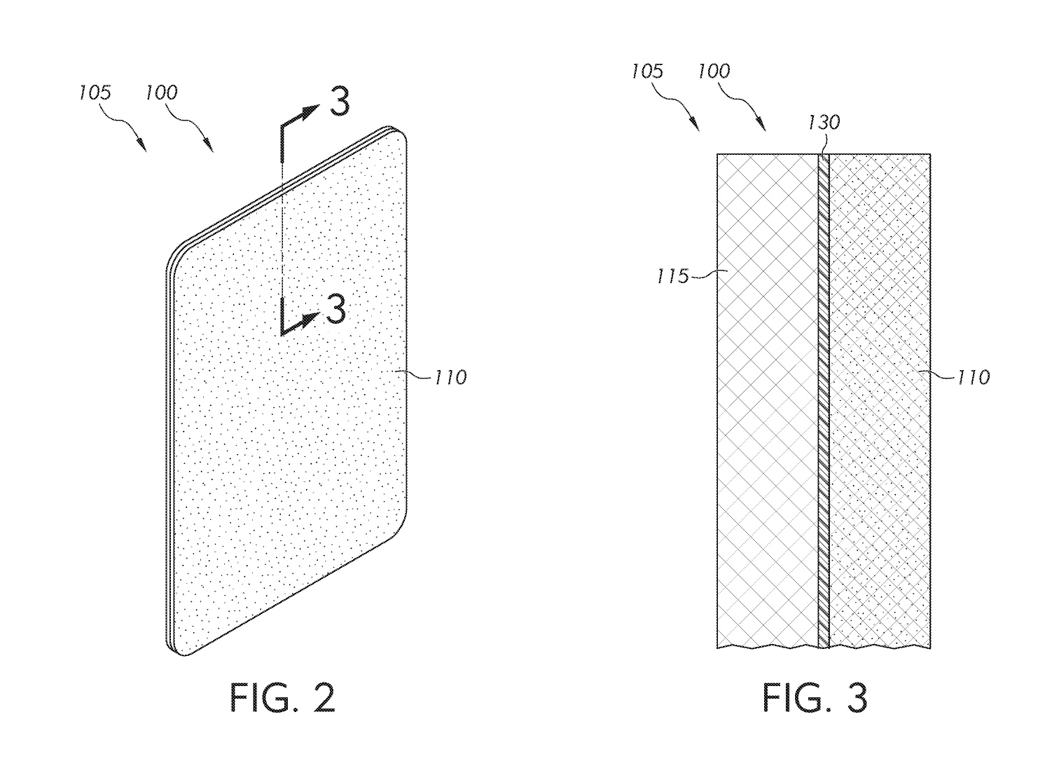

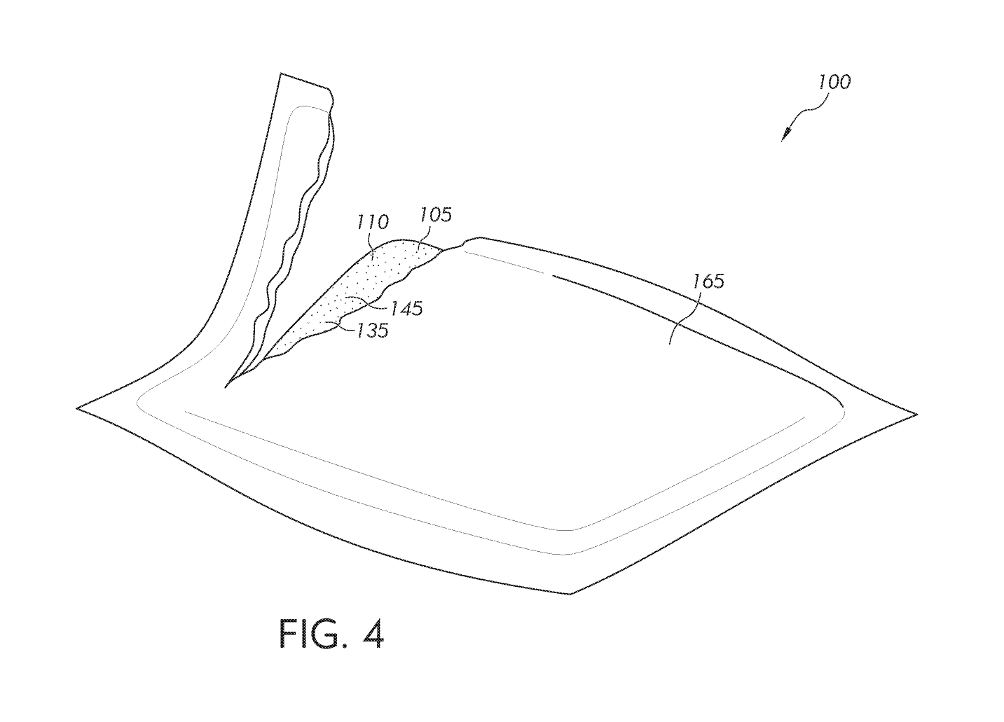

Referring now more specifically to the drawings by numerals of reference there is shown in FIGS. 1A-4, various views of a disposable double layered cleaning and disinfecting wipes system 100 in one embodiment, comprising a disposable cloth 105 including a first layer 110, a second layer 115, an adhesive 130, and a liquid chemical formula 120 having at least one cleaning and disinfecting agent 135.

The disposable cloth 105 is defined by the first layer 110 and the second layer 115 coupled together via the adhesive 130. The first layer 110 of the disposable cloth 105 is coated with the liquid chemical formula 120. The liquid chemical formula 120 may comprise in fluid combination at least one cleaning and disinfecting agent 135.

The second layer 115 of the disposable cloth 105 comprises a dry surface and is configured to absorb the liquid chemical formula 120 from a cleaned surface 160. The first layer 110 of the disposable double layered cleaning and disinfecting wipes of disposable double layered cleaning and disinfecting wipes system 100 is configured to allow a user 140 to clean a dirty surface 155 and the second layer 115 of the disposable double layered cleaning wipes is configured to allow a user 140 to dry the dirty surface 155. The disposable double layered cleaning and disinfecting wipes is disposable after use.

The first layer 110 may be composed of a threaded cloth material. The second layer 115 may be composed of a micro-fiber cloth material. The liquid chemical formula 120 may comprise a water component. The cleaning and disinfecting agent 135 may comprise an isopropyl alcohol component. The cleaning and disinfecting agent 135 may comprise an alkyl dimethyl benzyl ammonium chloride component. The cleaning and disinfecting agent 135 may comprise an alkyl polyglucoside component. The cleaning and disinfecting agent 135 may comprise a disodium ethylenediaminetetraacetic acid component. The cleaning and disinfecting agent 135 may comprise a propylene glycol propyl ether component. The liquid chemical formula 120 may comprise at least one fragrance component 145.

The dirty surface 155 may be a display screen of a mobile communication device 125. The dirty surface 155 may be a camera lens. The dirty surface 155 may be an eyeglass lens. The dirty surface 155 may be a mirror. The dirty surface 155 may be a glass surface.

In another embodiment, the disposable double layered cleaning and disinfecting wipes system 100 may comprise a square-shaped disposable cloth 105 including the first layer 110, the first layer 110 may be composed of a threaded cloth material, the second layer 115, the second layer 115 may be composed of a micro-fiber cloth material, the adhesive 130 and the liquid chemical formula 120 having at least one cleaning and disinfecting agent 135.

The square-shaped disposable cloth 105 is characterized by the first layer 110 and the second layer 115 coupled together via the adhesive 130. The first layer 110 of the square-shaped disposable cloth is coated with the liquid chemical formula 120. The liquid chemical formula 120 may comprise in fluid combination the cleaning and disinfecting agent 135. The liquid chemical formula 120 may further comprise at least one fragrance component 145. The second layer 115 of the square-shaped disposable cloth 105 comprises a dry surface and is configured to absorb the liquid chemical formula 120 from a cleaned surface 160.

The first layer 110 of the disposable double layered cleaning and disinfecting wipes is structured and arranged to allow a user 140 to clean and disinfect a dirty surface 155 and the second layer 115 of the disposable double layered cleaning and disinfecting wipes is structured and arranged to allow a user 140 to dry the dirty surface 155 and the disposable double layered cleaning and disinfecting wipes is disposable after use.

The cleaning and disinfecting agent 135 may comprise in fluid combination the water component, the isopropyl alcohol component, the alkyl dimethyl benzyl ammonium chloride component, the alkyl polyglucoside component, the disodium ethylenediaminetetraacetic acid component, and the propylene glycol propyl ether component.

The disposable double layered cleaning and disinfecting wipes system 100 may further comprise a disposable package 165 for removably-retaining the square-shaped disposable cloth 105 during an unused condition.

In a preferred embodiment, the disposable double layered cleaning and disinfecting wipes system 100 may comprise the square-shaped disposable cloth 105 including the first layer 110, the first layer 110 may be composed of the threaded cloth material, the second layer 115; the second layer 115 may be composed of the micro-fiber cloth material, the adhesive 130 and the liquid chemical formula 120 having at least one cleaning and disinfecting agent 135.

The disposable cloth 105 is defined by the first layer 110 and the second layer 115 coupled together via the adhesive 130. The first layer 110 of the disposable cloth 105 may be composed of the threaded cloth material configured to grip to and remove dirt particles from a dirty surface 155.

The first layer 110 of the disposable cloth 105 is coated with the liquid chemical formula 120. The liquid chemical formula 120 may comprise in fluid combination the water component, the isopropyl alcohol component, the alkyl dimethyl benzyl ammonium chloride component, the alkyl polyglucoside component, the disodium ethylenediaminetetraacetic acid component, the propylene glycol propyl ether component, and at least one fragrance component 145.

The second layer 115 of the disposable cloth 105 may be composed of the micro-fiber cloth material and is configured to provide a dry surface useful for the absorption of the liquid chemical formula 120 from the cleaned surface 160. The first layer 110 of the disposable double layered cleaning and disinfecting wipes is configured to allow a user 140 to clean the dirty surface 155 and the second layer 115 of the disposable double layered cleaning and disinfecting wipes is configured to allow a user 140 to dry the dirty surface 155 and the disposable double layered cleaning and disinfecting wipes is disposable after use.

The dirty surface 155 may include a display screen of a mobile communication device 125, a camera lens, an eyeglass lens, a mirror, a glass surface, a television screen, a display screen of a computer tablet, a display screen of a digital camera, and a display screen of a desktop computer monitor.

The disposable double layered cleaning and disinfecting wipes system 100 may further comprise a kit including the disposable cloth 105, the liquid chemical formula 120 having one cleaning and disinfecting agent 135, the disposable package 165 configured to retain the disposable cloth 105, the liquid chemical formula 120 and a set of user 140 instructions.

Disposable double layered cleaning and disinfecting wipes system 100 may be sold as a kit comprising the following parts: at least one disposable cloth 105; at least one liquid chemical formula 120 having at least one cleaning and at least one disinfecting agent; at least one disposable package 165 configured to retain the disposable cloth 105; and at least one set of user 140 instructions. The kit has instructions such that functional relationships are detailed in relation to the structure of the invention (such that the invention can be used, maintained, or the like in a preferred manner).

Disposable double layered cleaning and disinfecting wipes may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different fragrance combinations, parts may be sold separately, etc., may be sufficient.

A method of use for disposable double layered cleaning and disinfecting wipes system 100 may comprise the steps of: step one, tearing the disposable package 165; step two, opening the disposable package 165; step three, removing the disposable double layered cleaning and disinfecting wipe; step four, unfolding the disposable double layered cleaning and disinfecting wipe; step five, wiping the first layer 110 of the disposable double layered cleaning and disinfecting wipe over a dirty surface 155; step six, drying the cleaned surface 160 with the second layer 115 of the disposable double layered cleaning and disinfecting wipe; and step seven, disposing of the disposable double layered cleaning and disinfecting wipe.

It should be noted that the steps described in the method of use can be carried out in many different orders according to user preference. The use of “step of” should not be interpreted as “step for”, in the claims herein and is not intended to invoke the provisions of 35 U.S.C. §112 (f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A disposable double layered cleaning and disinfecting wipes system comprising:
a disposable cloth including;
a first layer;
a second layer; and
an adhesive; and
a liquid chemical formula having at least one cleaning and disinfecting agent;
wherein said disposable cloth is defined by said first layer and said second layer coupled together via said adhesive;
wherein said first layer of said disposable cloth is coated with said liquid chemical formula;
wherein said liquid chemical formula comprises in fluid combination said at least one cleaning and disinfecting agent;
wherein said second layer of said disposable cloth comprises a dry surface and is configured to absorb said liquid chemical formula from a cleaned surface;
wherein said first layer of said disposable double layered cleaning and disinfecting wipes is configured to clean and disinfect a dirty surface and said second layer of said disposable double layered cleaning and disinfecting wipes is configured to dry said dirty surface; and
wherein said disposable double layered cleaning and disinfecting wipes is disposable after use.

2. The disposable double layered cleaning and disinfecting wipes system of claim 1 wherein said first layer is composed of a threaded cloth material.

3. The disposable double layered cleaning and disinfecting wipes system of claim 2 wherein said second layer is composed of a micro-fiber cloth material.

4. The disposable double layered cleaning and disinfecting wipes system of claim 3 wherein said liquid chemical formula comprises a water component.

5. A disposable double layered cleaning and disinfecting wipes system of claim 4 wherein said at least one cleaning and disinfecting agent comprises an isopropyl alcohol component.

6. A disposable double layered cleaning and disinfecting wipes system of claim 5 wherein said at least one cleaning and disinfecting agent comprises an alkyl dimethyl benzyl ammonium chloride component.

7. A disposable double layered cleaning and disinfecting wipes system of claim 6 wherein said at least one cleaning and disinfecting agent comprises an alkyl polyglucoside component.

8. A disposable double layered cleaning and disinfecting wipes system of claim 7 wherein said at least one cleaning and disinfecting agent comprises a disodium ethylenediaminetetraacetic acid component.

9. A disposable double layered cleaning and disinfecting wipes system of claim 8 wherein said at least one cleaning and disinfecting agent comprises a propylene glycol propyl ether component.

10. A disposable double layered cleaning and disinfecting wipes system of claim 9 wherein said liquid chemical formula comprises at least one fragrance component.

11. The disposable double layered cleaning and disinfecting wipes system of claim 1 wherein said dirty surface is a display screen of a mobile communication device.

12. The disposable double layered cleaning and disinfecting wipes system of claim 1 wherein said dirty surface is a camera lens.

13. The disposable double layered cleaning and disinfecting wipes system of claim 1 wherein said dirty surface is an eyeglass lens.

14. The disposable double layered cleaning and disinfecting wipes system of claim 1 wherein said dirty surface is a mirror.

15. The disposable double layered cleaning and disinfecting wipes system of claim 1 wherein said dirty surface is a glass surface.

16. A disposable double layered cleaning and disinfecting wipes system comprising:
a square-shaped disposable cloth including;
a first layer, said first layer composed of a threaded cloth material;
a second layer, said second layer composed of a micro-fiber cloth material; and
an adhesive; and
a liquid chemical formula having at least one cleaning and disinfecting agent;
wherein said square-shaped disposable cloth is defined by said first layer and said second layer coupled together via said adhesive;
wherein said first layer of said square-shaped disposable cloth is coated with said liquid chemical formula;
wherein said liquid chemical formula comprises in fluid combination said at least one cleaning and disinfecting agent;
wherein said liquid chemical formula further comprises at least one fragrance component;
wherein said second layer of said square-shaped disposable cloth comprises a dry surface and is configured to absorb said liquid chemical formula from a cleaned surface;
wherein said first layer of said disposable double layered cleaning and disinfecting wipes is structured and arranged to clean and disinfect a dirty surface and said second layer of said disposable double layered cleaning and disinfecting wipes is structured and arranged to dry said dirty surface; and
wherein said disposable double layered cleaning and disinfecting wipes is disposable after use.

17. The disposable double layered cleaning and disinfecting wipes system of claim 16 wherein said at least one cleaning and disinfecting agent comprises in fluid combination a water component, an isopropyl alcohol component, an alkyl dimethyl benzyl ammonium chloride component, an alkyl polyglucoside component, a disodium ethylenediaminetetraacetic acid component, and a propylene glycol propyl ether component.

18. The disposable double layered cleaning and disinfecting wipes system of claim 17 further comprising a disposable package for removably-retaining said square-shaped disposable cloth during an unused condition.

19. A disposable double layered cleaning and disinfecting wipes system comprising:
a square-shaped disposable cloth including;
a first layer, said first layer composed of a threaded cloth material;
a second layer, said second layer composed of a micro-fiber cloth material; and
an adhesive; and
a liquid chemical formula having at least one cleaning and disinfecting agent;
wherein said disposable cloth is defined by said first layer and said second layer coupled together via said adhesive;
wherein said first layer of said disposable cloth is composed of a threaded cloth material configured to grip to and remove dirt particles from a dirty surface;
wherein said first layer of said disposable cloth is coated with said liquid chemical formula;
wherein said liquid chemical formula comprises in fluid combination a water component, an isopropyl alcohol component, an alkyl dimethyl benzyl ammonium chloride component, an alkyl polyglucoside component, disodium ethylenediaminetetraacetic acid component, a propylene glycol propyl ether component, and at least one fragrance component;
wherein said second layer of said disposable cloth is composed of a micro-fiber cloth material and is configured to provide a dry surface useful for the absorption of said liquid chemical formula from a cleaned surface;
wherein said first layer of said disposable double layered cleaning and disinfecting wipes is configured to clean and disinfect said dirty surface and said second layer of said disposable double layered cleaning and disinfecting wipes is configured to dry said dirty surface;
wherein said dirty surface includes a display screen of a mobile communication device, a camera lens, an eyeglass lens, a mirror, a glass surface, a television screen, a display screen of a computer tablet, a display screen of a digital camera, and a display screen of a desktop computer monitor; and
wherein said disposable double layered cleaning and disinfecting wipes is disposable after use.

20. The disposable double layered cleaning and disinfecting wipes of claim 19 further comprising a kit including:
said disposable cloth; and
said liquid chemical formula having said at least one cleaning and disinfecting agent;
a disposable package configured to retain said disposable cloth and said liquid chemical formula; and
a set of user instructions.
